(19) United States
(12) Patent Application Publication
(10) Pub. No.: US 2013/0306547 A1
(43) Pub. Date: Nov. 21, 2013

(54) PLEATED FILTER MEDIA WITH CONTINUALLY VARYING INTERMEDIATE PLEAT HEIGHTS

(71) Applicant: DOUGLAS A. D. NORRIS, CLEMMONS, NC (US)

(72) Inventor: DOUGLAS A. D. NORRIS, CLEMMONS, NC (US)

(73) Assignee: LYDALL, INC, MANCHESTER, CT (US)

(21) Appl. No.: 13/473,028

(22) Filed: May 16, 2012

(51) Int. Cl. B01D 27/06; D04H 3/04; B31B 1/26; B01D 27/08; B23P 17/00

(52) U.S. Cl. 210/485; 210/493.5; 210/493.1; 29/592; 493/405; 28/100

(57) ABSTRACT

Pleated filtration media and filtration devices generally include a filter media radially disposed about the annular perforated inner core, the filter media comprising a plurality of circumferentially disposed linear pleats extending from the inner core to a constant height (h) defined by an outer diameter; and one or more intermediate pleats circumferentially disposed between adjoining linear pleats, wherein each one of the intermediate pleats has a height less than the constant height, and wherein the height of the intermediate pleats progressively decreases in a clockwise or a counter clockwise direction. Also disclosed are methods for increasing surface area of a pleated filtration media.

### BACKGROUND

The present disclosure generally relates to filter media, and more particularly to, pleated filter media for use in cartridges having continually varying intermediate pleat heights.

Cartridge filter devices generally include top and bottom plates, an annular core, a cage spaced apart from the core, and a cylindrically shaped pleated filtration media intermediate the core and the cage. It is well known in the art that pleated filter media for cartridge filter devices and the like are generally limited with respect to filtration area due to geometric constraints of the cartridge itself For example, the outside diameter of the cartridge core limits the number of pleats that can be wrapped about the circumference of the core. Likewise, if a cage is present, the inside diameter of the cage limits the pleat height. Still further, the length of the cartridge provides additional limitations to the filtration area. For example, in a standard radially pleated filter cartridge such as disclosed in U.S. Pat. No. 3,692,184, the amount of filter media that may be packed into the cartridge is limited by the number of pleats that can be packed about the cartridge core. Consequently, there is substantial amount of empty space between adjacent pleats at the outer periphery of the filter element.

Prior art FIG. 1 illustrates a plan view of an exemplary standard filter cartridge including conventional radially pleated filter media. The pleats are indicated by reference numeral 1 and are connected to each other at outer ridges 2 and at inner ridges 3 which defines an outer circumference 4 having a diameter D1 and an inner circumference 5 having a diameter D2, respectively. The outer circumference can be defined by the outer cage, if present, and the inner circumference is defined by the annular core.

Performance of the filter element of this kind is mainly determined by total area of the filtering surface. The filtering surface area can be increased or enlarged either by increasing the dimension of each pleat 1 or by increasing the number of the pleats. The enlarged dimension of the pleat is obtained by increasing the diameter D1 and/or decreasing the diameter D2, but the filtering devices usually limit the size of filter element. On the other hand, by increasing arrangement density the number of the pleats per unit of volume can be increased to the extent that the two adjacent pleats can be separated from each other sufficiently to permit the fluid to flow therebetween and to minimize the loss of capacity due to the accumulation of dust, sludge and the like.

In the conventional element as illustrated in FIG. 1, the pleats 1 are arranged generally radially and are symmetrical with respect to the center of the cylinder. Therefore, the distance A2 between the adjacent inner ridges 3 is smaller than the distance A1 between the adjacent outer ridges 2. In other words, the density of the pleats 1 thus arranged is increased toward the inner circumference 5 and reduced toward the outer circumference 4. Consequently, even if the pleats 1 are so arranged as to have a density of maximum permissible value at around the inner circumference 5, there are necessarily created wasted volume at around the outer circumference 4. The pleated media can be configured to completely fill the outside diameter of the core (i.e., outer circumference 4 as shown in FIG. 1) whereas the cage inner diameter (i.e., inner circumference 5 as shown in FIG. 1) is never completely filled. This limits the efficiency of the filter element of the prior art.

Efforts to increase the filter area while minimizing filtration unit size have led to a variety of filter arrangements. For example, U.S. Pat. No. 3,799,354 describes W pleating, which is similar to and sometimes referred to as M pleating depending on the point of reference. W and M pleating configurations provide alternating intermediate pleats. The intermediate pleats extend partway from the cage wall towards the core and are typically of the same height. So called laid over pleats are disclosed in U.S. Pat. Nos. 5,543,047 and 5,690,765. The laid over pleat configuration generally includes a pleat height that is larger than the perpendicular height between the core and cage, which results in bending of the pleats so as to fit within the cartridge. As a result, the opposing surfaces of adjacent pleats are in intimate contact with one another over a substantial portion of the length of the filter element. U.S. Pat. No. 6,315,130 discloses pleated media having an intermediate pleat at every third pleat. U.S. Pat. No. 6,598,749 discloses having 2 different pleat heights within the cartridge.

While these prior art pleated filter cartridges are suitable for its intended use, it would be desirable to further improve filtration area while minimizing unit size.

### BRIEF SUMMARY

Disclosed herein are filtration media and filtration devices. In one embodiment, pleated filtration media for a filter cartridge comprises a plurality of circumferentially disposed linear pleats extending from a constant inner core diameter (d) to a constant height (h) defined by an outer diameter; and one or more intermediate pleats circumferentially disposed between a plurality of adjoining linear pleats, wherein each one of the intermediate pleats has a height less than the constant height, and wherein the height of the intermediate pleats progressively decreases in a clockwise or a counter clockwise direction.

In another embodiment, a pleated filtration media comprises a plurality of circumferentially disposed linear pleats extending from a constant inner core diameter (d) to a constant height (h) defined by an outer diameter; and one or more intermediate pleats circumferentially disposed between a plurality of adjoining linear pleats, wherein each one of the intermediate pleats has a different height relative to another intermediate pleat.

A filtration cartridge comprises an annular perforated inner core having a constant diameter; a filter media radially disposed about the annular perforated inner core, the filter media comprising a plurality of circumferentially disposed linear pleats extending from the inner core to a constant height (h) defined by an outer diameter; and one or more intermediate pleats circumferentially disposed between a plurality of adjoining linear pleats, wherein each one of the intermediate pleats has a height less than the constant height, and wherein the height of the intermediate pleats progressively decreases in a clockwise or a counter clockwise direction; and end caps disposed at each end, wherein at least one of the end caps includes an inlet in fluid communication with the annular perforated inner core.

A method for maximizing surface area for a pleated filtration media for a cartridge filter comprises forming a plurality of circumferentially disposed linear pleats extending from the inner core to a constant height (h) defined by an outer diameter; and forming one or more intermediate pleats between a plurality of adjoining linear pleats, wherein each one of the intermediate pleats has a height less than the constant height, and wherein the height of each one of the intermediate pleats is different.

The disclosure may be understood more readily by reference to the following detailed description of the various features of the disclosure and the examples included therein.

### BRIEF DESCRIPTION OF THE DRAWINGS

Referring now to the figures wherein the like elements are numbered alike:

FIG. 1 depicts a plan view of a prior art pleated filter element;

FIG. 2 depicts a plan view of a pleated filter element in accordance with the present disclosure;

FIG. 3 is a cutaway perspective view of a filtration device suitable for use with the radial pleated media of the present disclosure;

FIG. 4 depicts a plan view of pleated radial filter media having intermediate pleats in accordance with an embodiment of the present disclosure and conventional radial filter media without intermediate pleats.

### DETAILED DESCRIPTION

The present disclosure is generally directed to a pleated filtration media, i.e., a filtration element, suitable for use in filtration cartridges. The pleated filtration element generally includes a plurality of circumferentially disposed pleats and a plurality of intermediate pleats, wherein the intermediate pleats have varying heights. In one embodiment, the intermediate pleat heights progressively vary about the circumference of filtration element. The pleated filtration element in accordance with the present disclosure maximizes filtration area, thereby overcoming many of the problems noted with the prior art. Hold-up volume is significantly minimized and a higher pleat density is obtained leading to increased stiffness, among other advantages. The filtration element can be employed to filter a variety of fluids including gases and liquids.

The particular filtration element is not intended to be limited to any particular material and may include materials such as felt, paper, wet laid paper, glass fiber, microporous membranes, multilayered composite, and combinations thereof, so long as the material can be pleated. Likewise, the filtration element can be utilized in any radially constructed filtration device such as a cartridge filter.

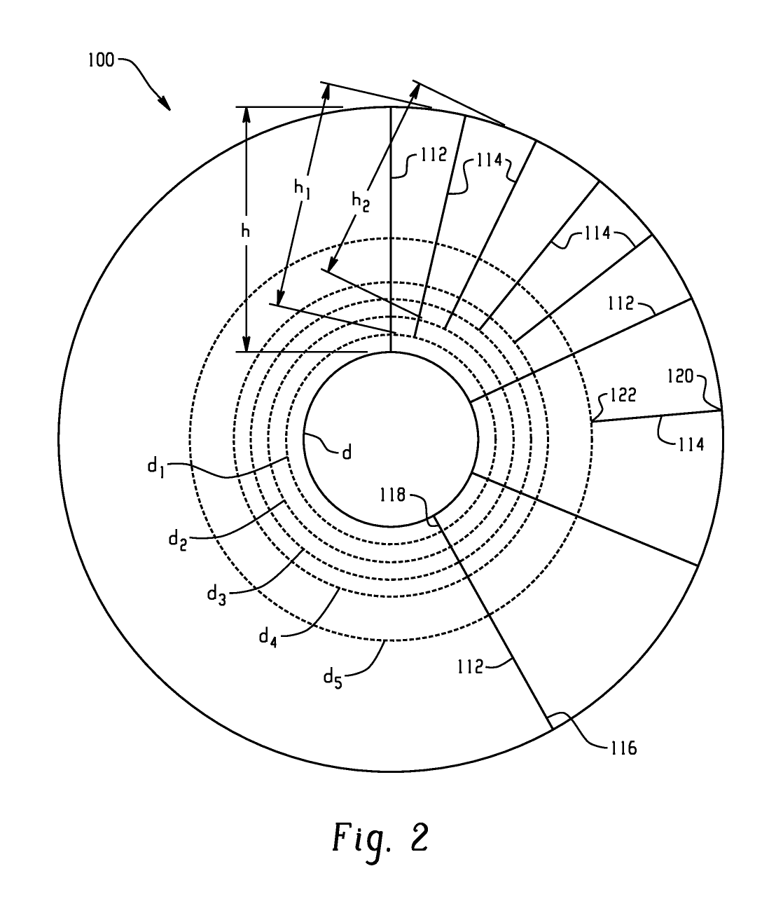

FIG. 2 illustrates an exemplary pleated filter element 100 in accordance with one embodiment. The pleated filter element 100 includes a plurality of circumferentially disposed pleats 112 extending about a constant inner core diameter (d) to a height (h) defined by an outer diameter. The pleated filter element 100 further includes a plurality of intermediate pleats 114, wherein each one of the intermediate pleats 114 have different heights. Moreover, it should be apparent that the heights of all intermediate pleats 114 are less than pleats 112. In other embodiments, the intermediate pleats 114 have a progressively decreased height about the circumference of the element 100, whether it be in a clockwise or counterclockwise direction. That is, the intermediate pleats 114 have a progressively increasing diameter and decreased height about the circumference of the core.

For ease of understanding, FIG. 2 depicts four pleats 112 and five intermediate pleats 114. However, it should be apparent that the pleated filter element is not intended to be limited to any particular number of pleats 112 and intermediate pleats 114. The particular number of each respective pleat 112 or 114 will generally depend on the type and thickness of the filter material itself, the core diameter, and the desired application. Moreover, the number of intermediate pleats 114 disposed between pleats 112 can generally be none, one or more depending on the desired application so long as each adjacent intermediate pleat as it circumscribes the core has an increasing diameter and decreased height relative to one another. Consequently, it should be apparent that the intermediate pleats can be symmetrically or asymmetrically disposed about the core. For example, one intermediate pleats may be disposed between adjoining linear pleats 112 whereas other adjoining pleats 112 may have no or multiple intermediate pleats therebetween. In one embodiment, one intermediate pleat 114 is alternatingly disposed between each pair of adjoin pleats 112, wherein each adjacent intermediate pleat 114 progressively increases in diameter and decreases in height, i.e., symmetrically disposed about the circumference.

The circumferentially disposed pleats 112 have outer ridges 116 that define the outermost diameter of the filter material 100 and inner ridges 118 radially disposed about the outer diameter (d) of the core. The outermost diameter is constant. In some embodiments, the outer ridges abut a cage wall.

The intermediate pleats 114 also have outer ridges 120 and inner ridges 122. The inner ridges 122 of the circumferentially disposed pleats 114 have a progressively increasing diameter (d₁, d₂, d₃, . . . dₙ), wherein d₁>d; d₂>d₁; d₃>d₂, and so on. The outer ridges 120 are at the same diameter as outer ridges 116 of pleats 112. Consequently, the intermediate pleats 114 have a height that progressively decreases, e.g., h>h₁; h₁>h₂; h₂>h₃; and so on. By increasing arrangement density in this manner, the number of the pleats per unit of volume can be increased to the extent that the two adjacent pleats can be separated from each other sufficiently to permit the fluid to flow therebetween and to minimize the loss of capacity due to the accumulation of dust, sludge and the like.

Since the number of conventional radial pleats is limited by the circumference of the core diameter d, the first intermediate pleat cannot be introduced at any diameter less than what can fit both the conventional radial pleat count plus one intermediate pleat. For conventional radial pleating, the number of pleats “N” is determined by the circumference of “d” and can be mathematically represented by formula (1):

N=πd/2t, (1)

wherein “d” is the core diameter, i.e., the core outside diameter, and “t” is the thickness of the filter media with its optional support materials. Rearranging formula (1), the core outside diameter “d” can then be expressed by mathematical formula (2):

d=2tN/π. (2)

Thus, the first intermediate pleat can occur at an inside diameter “d₁” with height “h₁”.

d1=d+2t/π (3)

h1=(D−d₁)/2, (4)

wherein D is the outermost diameter of the pleated filter material as defined by outer ridge 116 of pleats 112, e.g., inside diameter of the cage, if present. Additional intermediate pleats can be added in the same manner such as is mathematically defined in formulas (5) and (6).

d2=d1+2t/π (5)

h₂=(D−d₂)/2 (6)

As this practice is continued, the pleat heights, e.g., h₃, h₄, h₅, etc., will become successively smaller and can be accomplished with a computer controlled pleater. At some point, the increase in area (Area=2(h)(N)(L)) provided by progressively increased diameter intermediate pleats will be minimal Likewise, the filter material properties, e.g., composition, thickness, and the like, may limit the number of intermediate pleats that can be formed.

The pleated filter material of the present disclosure can be manufactured by a variety of techniques. In general, however, the filtration material and support media, if any, to be pleated may be stored on separate rolls and simultaneously fed to a pleating machine and pleated.

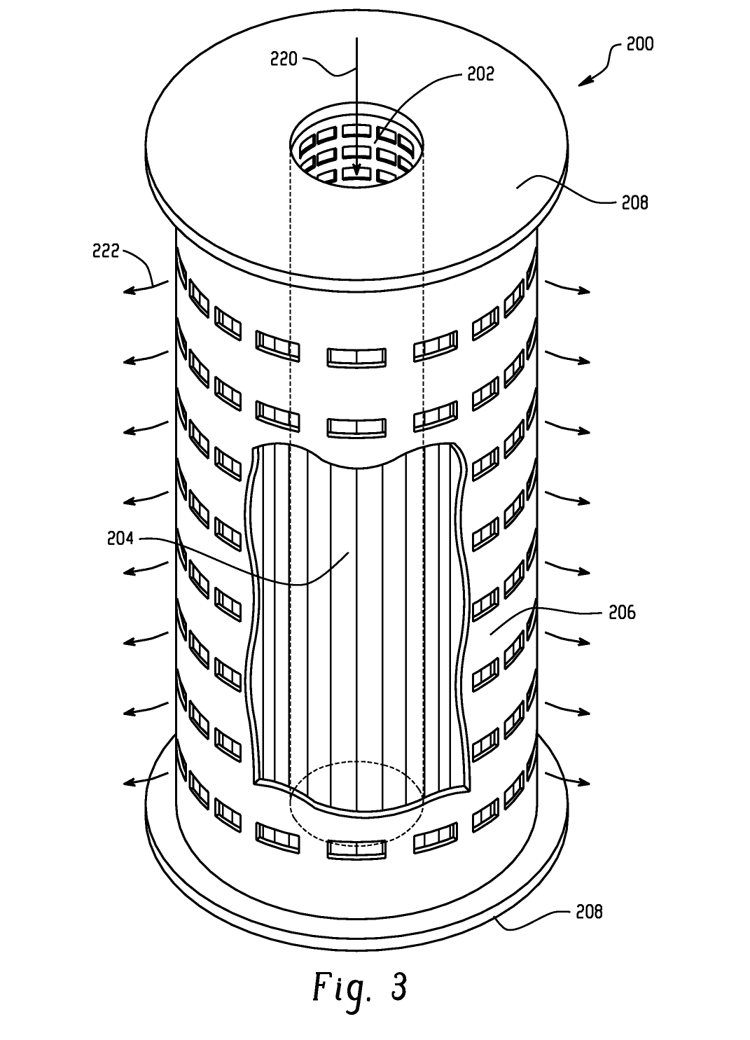

Referring now to FIG. 3, there is depicted a partial cutaway perspective view of an exemplary, non-limiting, radial filter device 200 suitable for use with the continually variable intermediate pleat filtration element disclosed herein. It should be apparent that the filtration media having maximal surface area as described herein could be adapted for use for geometries other than circular. The illustrated filter device 200 generally includes a perforated inner core 202, a pleated filtration material 204 in accordance with the present disclosure, an optional perforated outer cage 206 and end caps 208. The filter element 204 is radially disposed between the inner core 202 and the perforated outer cage 206. Inner core 202 supports the inner periphery of pleated filter material 204 against forces in the radial direction and also helps to give filter 200 axial strength and rigidity against bending. Outer cage 206 retains the pleats of the filter material 204 in a cylindrical pleated configuration and, similarly to inner core 202, outer cage 206 supports the outer periphery of filter material 204 against forces in the radial direction and also helps to give filter 200 axial strength and rigidity against bending in the event that the filter element lacks sufficient strength and rigidity. It is envisioned that means other than outer cage 206 may be provided to retain the pleats. For example, a polymeric netting or mesh material may be utilized to retain the pleats about the outer periphery of the filter. Alternative outer cages (not shown) include an expandable mesh sleeve, a porous extruded tube, or a wrap consisting of cord, woven or non-woven material. The material of which outer cage 206 is made can be selected based on the fluid being filtered and the filtering conditions. The end caps 208 are at each end of the device, wherein a selected one of the end caps 208 includes an inlet as indicated by arrow 220 for introducing fluid to be filtered to the inner core 202. Conventional techniques can be used to attach end caps 208 to the components of filter media, for example, such as by use of an epoxy, by thermal bonding or by spin welding.

The operation of the filtration cartridge will generally depend on the configuration and end application for the filter device. In one embodiment, fluid flows through inlet 220 of the device 200 and through the filter element 204 as indicated by arrows 222 to effect filtration of the fluid. The filter fluid then flows through the perforations of the perforated outer cage 216, wherein the filtered fluid may be used or further processed depending on the particular application. Alternatively, the fluid flow can be in an opposite direction. That is, fluid flows through the outer cage, through the pleated filter element, and then is discharged thought an outlet disposed in an end cap.

The following examples are presented for illustrative purposes only, and are not intended to limit the scope of the invention.

### EXAMPLE 1

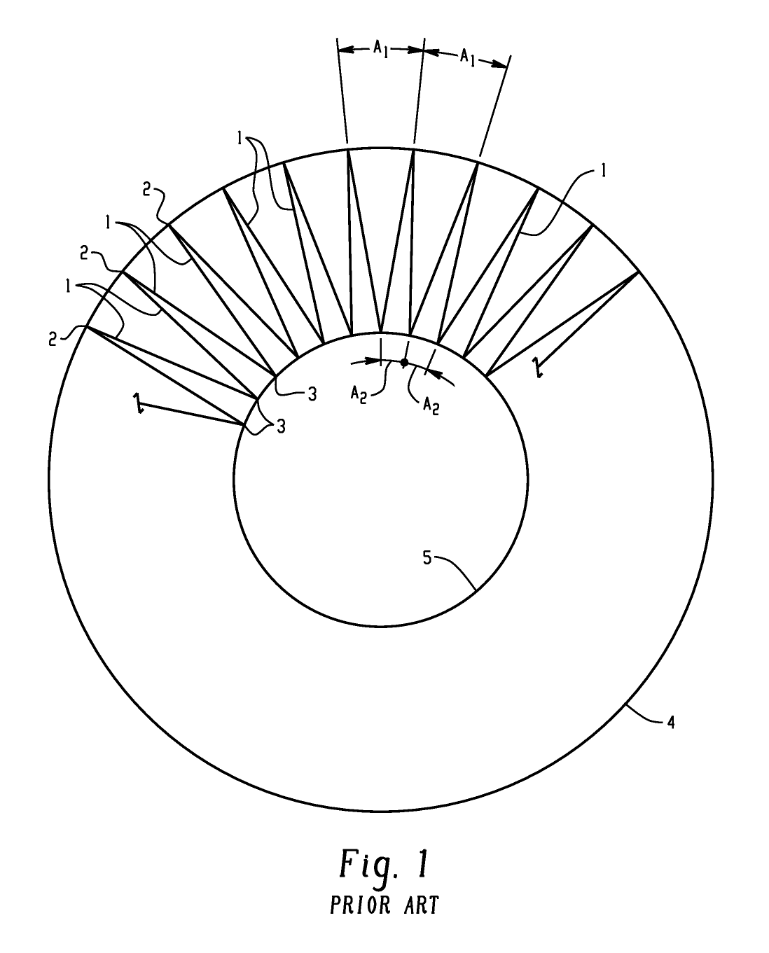

In this example, total filtration area was measured as a function of increasing the number of intermediate pleats from 0 to 11 in a conventional radial filter material (e.g., similar to the radial pleat configuration shown in FIG. 1) having 13 radial pleats, a diameter (D) of 2.75 inches, a core diameter (d) of 1.200 inches, a height (h) of 0.775 inches, length (L) of 10 inches and a material thickness (t) of 0.175 inches. The diameter (dₙ), height (h), number of pleats (N) and corresponding increase in area on an individual basis (Aₙ) and a cumulative basis (Aₜₒₜₐₗ) were then measured for each additional intermediate pleat added to the filter material. The results are shown in Table 1.

TABLE 1

| | dn | N | h | Aₙ | Aₜₒₜₐₗ |
|---|---|---|---|---|---|
| d | 1.200 | 13 | 0.775 | 201.5 | 201.5 |
| d1 | 1.311 | 14 | 0.719 | 14.4 | 215.9 |
| d2 | 1.423 | 15 | 0.664 | 13.3 | 229.2 |
| d3 | 1.534 | 16 | 0.608 | 12.2 | 241.3 |
| d4 | 1.646 | 17 | 0.552 | 11.0 | 252.4 |
| d5 | 1.757 | 18 | 0.496 | 9.9 | 262.3 |
| d6 | 1.868 | 19 | 0.441 | 8.8 | 271.1 |
| d7 | 1.980 | 20 | 0.385 | 7.7 | 278.8 |
| d8 | 2.091 | 21 | 0.329 | 6.6 | 285.4 |
| d9 | 2.203 | 22 | 0.274 | 5.5 | 290.9 |
| d10 | 2.314 | 23 | 0.218 | 4.4 | 295.2 |
| d11 | 2.425 | 24 | 0.162 | 3.2 | 298.5 |

As demonstrated, the pleated filter material without any intermediate pleats had a total filtration area of 201.5 in². Each intermediate pleat that was added to the filter element configuration was at a progressively increasing diameter and decreasing height. Moreover, the contribution to total filtration area generally decreased as a function of increasing number of intermediate pleats. The total area provided by the addition of 11 intermediate pleats in this manner was 298.5 in².

### EXAMPLE2

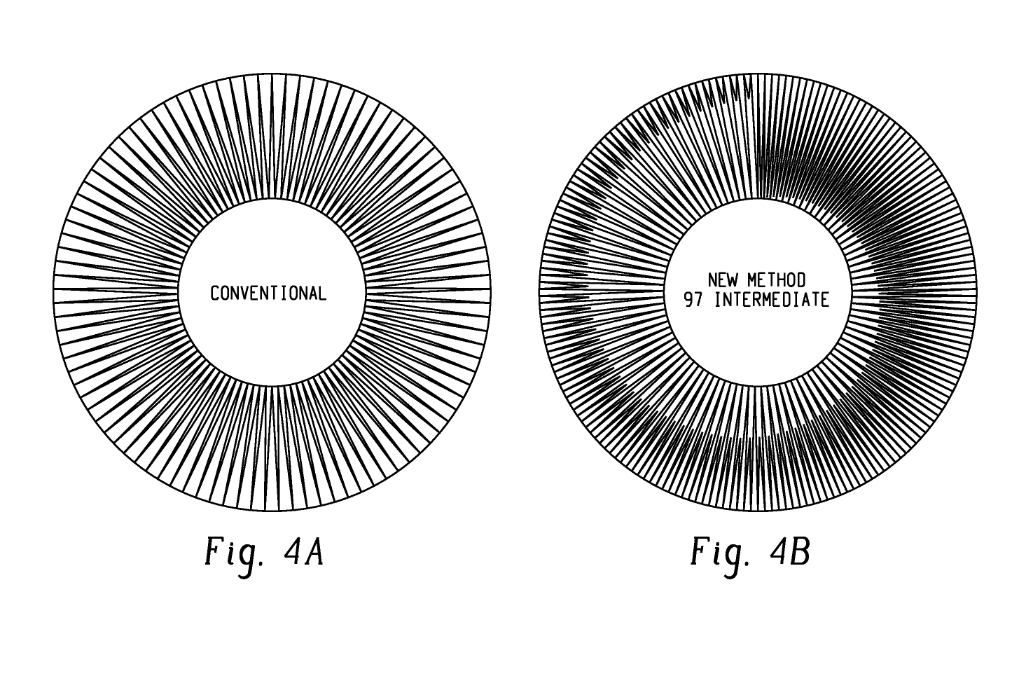

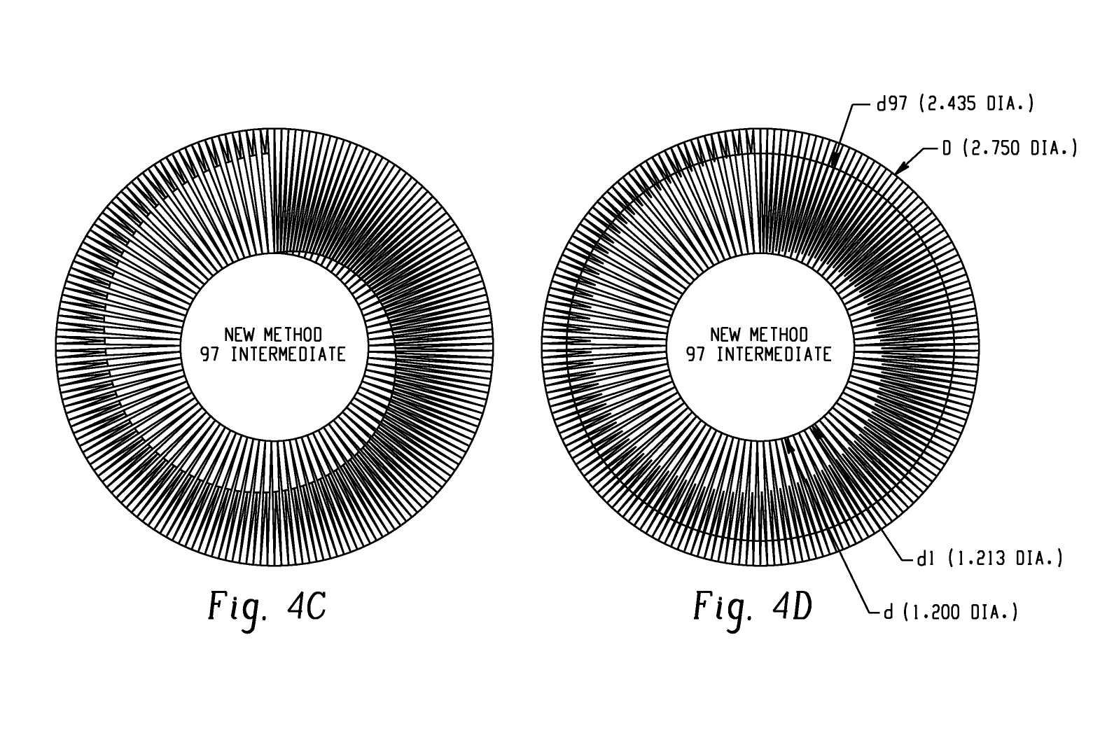

In this example, total filtration area was measured as a function of increasing the number of intermediate pleats from 0 to 118 in a conventional radial filter material (e.g., similar to the radial pleat configuration shown in FIG. 1) having 97 radial pleats, a diameter (D) of 2.75 inches, a core diameter (d) of 1.200 inches, a height of 0.775 inches, a length (L) of 10 inches, and a material thickness of about 0.020 inches. FIG. 4 schematically illustrates the pleated filter media with the 118 intermediate pleats and a conventional radial filter having circumferentially disposed pleats extending about a constant inner core diameter (d) extending to a constant height (h) defined by an outer diameter.

The total area is calculated as follows. A=2(h)(N)(L). When the number of radial pleats (N) is equal to 97 having a height (h) of 0.775 (h=(2.75−1.2)/2) and a length (L), the total area is 1503.5 square inches (Aₜₒₜₐₗ=2(0.775)(97)(10). The area for each successive intermediate pleat is calculated in the following manner: d1=d+2t/π=1.200+2(0.20)/π=1.213; h1=(D−d1)/2=(2.75−1.213)/2=0.769 inches; A₁=2(h₁)(N)(L)=2(0.769)(1)(10)=15.4 square inches. As such, including one intermediate pleat increases the total area to 1518.9 square inches (Aₜₒₜₐₗ=1503.5+15.4). Adding a second pleat would be calculated in a similar manner. For example, the areas attributed to a second pleat is calculated as follows: d₂=1.2+2(2)(0.020)=1.225; h₂=(2.75−1.225)/2=0.762; A2=2(0.762)(1)(10)=15.2 square inches. Thus the total area provided by a pleated filter media having 97 radial pleats and two intermediate pleats is 1503.5+15.4+15.2=1534.1 square inches. As would be expected, since each additional intermediate pleat is at a progressively smaller height, the contribution to total surface area decreases as evidenced by the results are shown in Table 2.

TABLE 2

| | dn | N | h | Aₙ | Aₜₒₜₐₗ |
|---|---|---|---|---|---|
| d | 1.200 | 97 | 0.775 | 1503.5 | 1503.5 |
| d1 | 1.213 | 98 | 0.769 | 15.4 | 1518.9 |
| d2 | 1.225 | 99 | 0.762 | 15.2 | 1534.1 |
| d3 | 1.238 | 100 | 0.756 | 15.1 | 1549.2 |
| d4 | 1.251 | 101 | 0.750 | 15.0 | 1564.2 |
| d5 | 1.264 | 102 | 0.743 | 14.9 | 1579.1 |
| d6 | 1.276 | 103 | 0.737 | 14.7 | 1593.8 |
| d7 | 1.289 | 104 | 0.730 | 14.6 | 1608.4 |
| d8 | 1.302 | 105 | 0.724 | 14.5 | 1622.9 |
| d9 | 1.315 | 106 | 0.718 | 14.4 | 1637.3 |
| d10 | 1.327 | 107 | 0.711 | 14.2 | 1651.5 |
| d11 | 1.340 | 108 | 0.705 | 14.1 | 1665.6 |
| d12 | 1.353 | 109 | 0.699 | 14.0 | 1679.6 |
| d13 | 1.366 | 110 | 0.692 | 13.8 | 1693.4 |
| d14 | 1.378 | 111 | 0.686 | 13.7 | 1707.1 |
| d15 | 1.391 | 112 | 0.680 | 13.6 | 1720.7 |
| d16 | 1.404 | 113 | 0.673 | 13.5 | 1734.2 |
| d17 | 1.416 | 114 | 0.667 | 13.3 | 1747.5 |
| d18 | 1.429 | 115 | 0.660 | 13.2 | 1760.7 |
| d19 | 1.442 | 116 | 0.654 | 13.1 | 1773.8 |
| d20 | 1.455 | 117 | 0.648 | 13.0 | 1786.8 |
| d21 | 1.467 | 118 | 0.641 | 12.8 | 1799.6 |
| d22 | 1.480 | 119 | 0.635 | 12.7 | 1812.3 |
| d23 | 1.493 | 120 | 0.629 | 12.6 | 1824.9 |
| d24 | 1.506 | 121 | 0.622 | 12.4 | 1837.3 |
| d25 | 1.518 | 122 | 0.616 | 12.3 | 1849.6 |
| d26 | 1.531 | 123 | 0.609 | 12.2 | 1861.8 |
| d27 | 1.544 | 124 | 0.603 | 12.1 | 1873.9 |
| d28 | 1.557 | 125 | 0.597 | 11.9 | 1885.8 |
| d29 | 1.569 | 126 | 0.590 | 11.8 | 1897.6 |
| d30 | 1.582 | 127 | 0.584 | 11.7 | 1909.3 |
| d31 | 1.595 | 128 | 0.578 | 11.6 | 1920.8 |
| d32 | 1.607 | 129 | 0.571 | 11.4 | 1932.3 |
| d33 | 1.620 | 130 | 0.565 | 11.3 | 1943.6 |
| d34 | 1.633 | 131 | 0.559 | 11.2 | 1954.7 |
| d35 | 1.646 | 132 | 0.552 | 11.0 | 1965.8 |
| d36 | 1.658 | 133 | 0.546 | 10.9 | 1976.7 |
| d37 | 1.671 | 134 | 0.539 | 10.8 | 1987.5 |
| d38 | 1.684 | 135 | 0.533 | 10.7 | 1998.2 |
| d39 | 1.697 | 136 | 0.527 | 10.5 | 2008.7 |
| d40 | 1.709 | 137 | 0.520 | 10.4 | 2019.1 |
| d41 | 1.722 | 138 | 0.514 | 10.3 | 2029.4 |
| d42 | 1.735 | 139 | 0.508 | 10.2 | 2039.5 |
| d43 | 1.747 | 140 | 0.501 | 10.0 | 2049.6 |
| d44 | 1.760 | 141 | 0.495 | 9.9 | 2059.4 |
| d45 | 1.773 | 142 | 0.489 | 9.8 | 2069.2 |
| d46 | 1.786 | 143 | 0.482 | 9.6 | 2078.9 |
| d47 | 1.798 | 144 | 0.476 | 9.5 | 2088.4 |
| d48 | 1.811 | 145 | 0.469 | 9.4 | 2097.8 |
| d49 | 1.824 | 146 | 0.463 | 9.3 | 2107.0 |
| d50 | 1.837 | 147 | 0.457 | 9.1 | 2116.2 |
| d51 | 1.849 | 148 | 0.450 | 9.0 | 2125.2 |
| d52 | 1.862 | 149 | 0.444 | 8.9 | 2134.0 |
| d53 | 1.875 | 150 | 0.438 | 8.8 | 2142.8 |
| d54 | 1.888 | 151 | 0.431 | 8.6 | 2151.4 |
| d55 | 1.900 | 152 | 0.425 | 8.5 | 2159.9 |
| d56 | 1.913 | 153 | 0.418 | 8.4 | 2168.3 |
| d57 | 1.926 | 154 | 0.412 | 8.2 | 2176.5 |
| d58 | 1.938 | 155 | 0.406 | 8.1 | 2184.6 |
| d59 | 1.951 | 156 | 0.399 | 8.0 | 2192.6 |
| d60 | 1.964 | 157 | 0.393 | 7.9 | 2200.5 |
| d61 | 1.977 | 158 | 0.387 | 7.7 | 2208.2 |
| d62 | 1.989 | 159 | 0.380 | 7.6 | 2215.8 |
| d63 | 2.002 | 160 | 0.374 | 7.5 | 2223.3 |
| d64 | 2.015 | 161 | 0.368 | 7.4 | 2230.7 |
| d65 | 2.028 | 162 | 0.361 | 7.2 | 2237.9 |
| d66 | 2.040 | 163 | 0.355 | 7.1 | 2245.0 |
| d67 | 2.053 | 164 | 0.348 | 7.0 | 2252.0 |
| d68 | 2.066 | 165 | 0.342 | 6.8 | 2258.8 |
| d69 | 2.079 | 166 | 0.336 | 6.7 | 2265.5 |
| d70 | 2.091 | 167 | 0.329 | 6.6 | 2272.1 |
| d71 | 2.104 | 168 | 0.323 | 6.5 | 2278.6 |
| d72 | 2.117 | 169 | 0.317 | 6.3 | 2284.9 |
| d73 | 2.129 | 170 | 0.310 | 6.2 | 2291.1 |
| d74 | 2.142 | 171 | 0.304 | 6.1 | 2297.2 |
| d75 | 2.155 | 172 | 0.298 | 6.0 | 2303.1 |
| d76 | 2.168 | 173 | 0.291 | 5.8 | 2309.0 |
| d77 | 2.180 | 174 | 0.285 | 5.7 | 2314.6 |
| d78 | 2.193 | 175 | 0.278 | 5.6 | 2320.2 |
| d79 | 2.206 | 176 | 0.272 | 5.4 | 2325.7 |
| d80 | 2.219 | 177 | 0.266 | 5.3 | 2331.0 |
| d81 | 2.231 | 178 | 0.259 | 5.2 | 2336.2 |
| d82 | 2.244 | 179 | 0.253 | 5.1 | 2341.2 |
| d83 | 2.257 | 180 | 0.247 | 4.9 | 2346.1 |
| d84 | 2.270 | 181 | 0.240 | 4.8 | 2351.0 |
| d85 | 2.282 | 182 | 0.234 | 4.7 | 2355.6 |
| d86 | 2.295 | 183 | 0.228 | 4.6 | 2360.2 |
| d87 | 2.308 | 184 | 0.221 | 4.4 | 2364.6 |
| d88 | 2.320 | 185 | 0.215 | 4.3 | 2368.9 |
| d89 | 2.333 | 186 | 0.208 | 4.2 | 2372.1 |
| d90 | 2.346 | 187 | 0.202 | 4.0 | 2377.1 |
| d91 | 2.359 | 188 | 0.196 | 3.9 | 2381.0 |
| d92 | 2.371 | 189 | 0.189 | 3.8 | 2384.8 |
| d93 | 2.384 | 190 | 0.183 | 3.7 | 2388.5 |
| d94 | 2.397 | 191 | 0.177 | 3.5 | 2392.0 |
| d95 | 2.410 | 192 | 0.170 | 3.4 | 2395.4 |
| d96 | 2.422 | 193 | 0.164 | 3.3 | 2398.7 |
| d97 | 2.435 | 194 | 0.157 | 3.1 | 2401.8 |
| d98 | 2.448 | 195 | 0.151 | 3.0 | 2404.9 |
| d99 | 2.461 | 196 | 0.145 | 2.9 | 2407.7 |
| d100 | 2.473 | 197 | 0.138 | 2.8 | 2410.5 |
| d101 | 2.486 | 198 | 0.132 | 2.6 | 2413.2 |
| d102 | 2.499 | 199 | 0.126 | 2.5 | 2415.7 |
| d103 | 2.511 | 200 | 0.119 | 2.4 | 2418.1 |
| d104 | 2.524 | 201 | 0.113 | 2.3 | 2420.3 |
| d105 | 2.537 | 202 | 0.107 | 2.1 | 2422.4 |
| d106 | 2.550 | 203 | 0.100 | 2.0 | 2424.4 |
| d107 | 2.562 | 204 | 0.094 | 1.9 | 2426.3 |
| d108 | 2.575 | 205 | 0.087 | 1.7 | 2428.1 |
| d109 | 2.588 | 206 | 0.081 | 1.6 | 2429.7 |
| d110 | 2.601 | 207 | 0.075 | 1.5 | 2431.2 |
| d111 | 2.613 | 208 | 0.068 | 1.4 | 2432.6 |
| d112 | 2.626 | 209 | 0.062 | 1.2 | 2433.8 |
| d113 | 2.639 | 210 | 0.056 | 1.1 | 2434.9 |
| d114 | 2.651 | 211 | 0.049 | 1.0 | 2435.9 |
| d115 | 2.664 | 212 | 0.043 | 0.9 | 2436.7 |
| d116 | 2.677 | 213 | 0.037 | 0.7 | 2437.5 |
| d117 | 2.690 | 214 | 0.030 | 0.6 | 2438.1 |
| d118 | 2.702 | 215 | 0.024 | 0.5 | 2438.6 |

As demonstrated in Table 2, total filtration area was increased to 2438.6 in² for the pleated filtration material with 118 intermediate pleats of successively increasing diameter and corresponding decrease in height compared to the pleated filtration material having a conventional radial configuration similar to that shown in FIG. 1, which provided a total filtration area of 1503.5 in².

### EXAMPLE3

In this example, the filtration area of a pleated filter cartridge of Example 2 was compared to various prior art pleated filter materials at the same material thicknesses. The various prior art pleated filter materials included a radial pleating type; a laid over pleating type such as is disclosed in U.S. Pat. No. 5,543,047; an “M” pleating type; a “W” pleating type; and an intermediate third pleating type as disclosed in U.S. Pat. No. 6,315,130. The basis for each pleat type was the same as in Example 2 and included 97 radial pleats, a core diameter of 1.200 inches, a height of 0.775 inches, a material thickness of about 0.020 inches, and length of 10 inches.

In the “M” pleat type, the filtration area calculations assumed every fourth pleat to be an “M” pleat. It was determined that if the “M” pleat number were every second pleat, i.e., equal number of pleats as the radial pleat type without intermediate pleats, that the calculated pleat height (hₘ) would be 0.005 inches, which would be impractical from a design aspect. Making every 4^{th} pleat an “M” pleat, the following calculations were used to determine total filtration area.

Nₘ=1/3N=1/3*97=32 intermediate pleats

Nₜₒₜₐₗ=97+32=129

dₘ=(2)(t)(Nₜₒₜₐₗ)/π=2*0.020 in.*129/π=1.642 in.

hₘ=(D−dₘ)/2=(2.75 in.−1.2 in)/2=0.554 in.

Aₘ=2hₘNₘL=2*0.554 in*32*10 in=354.6 in²

Aₜₒₜₐₗ=1503.5 in²+354.6=1858.1 in²

In the “W′ pleat type, the filtration area calculations assumed every second pleat of the radial pleat type was modified with a “W” pleat. As noted in Example 2 the total number of radial pleats without any intermediate pleats was 97 (see Table 2). The filtration area was calculated in the following manner

Nₜₒₜₐₗ=97+97=194

d_{w}=(2)(t)(Nₜₒₜₐₗ)/π=2*0.020 in*194/π=2.470 in.

h_{w}=(D−d_{w}/2=(2.75 in.−2.470 in.)/2=0.140 in.

A₂=2h_{w}N_{w}L=2*0.140 in*97*10 in=271.6 in²

Aₜₒₜₐₗ=1503.5 in²+271.6 in²=1775.1 in²

In the “intermediate third pleat” type, the filtration area calculations assumed every third pleat to be an intermediate pleat. Thus, for every 2 radial pleats, there is 1 intermediate pleat. The total filtration area was calculated in a similar manner as provided for in Table 2 with the exception that Nₜₒₜₐₗ=97+48=145. As shown in Table 2 above, the total area provided from the addition of 48 pleats (N=145) is 2097.8.

The results are summarized in Table 3 below.

TABLE 3

| | Material | Area | |
|---|---|---|---|
| Pleat Pack Type | Thickness (in) | (in²) | Comments |
| Continually | ~0.020 | 2438.6 | Inventive |
| Varying Pleats | | | |
| Radial | ~0.020 | 1503.5 | Comparative |
| Laid Over | ~0.020 | 2394.7 | Comparative |
| “M” Pleat | ~0.020 | 1858.1 | Comparative |
| “W” Pleat | ~0.020 | 1775.1 | Comparative |
| Intermediate | ~0.020 | 2097.8 | Comparative |
| Third Pleat | | | |

As demonstrated in Table 3, filtration area was maximized by with the filter media having the continually varying intermediate pleats as described herein.

Advantageously, the pleated cartridge filter media in accordance with the present disclosure uses conventional pleated cartridge methods and adds intermediate pleats to the pleat pack to maximize filtration area. The filter cartridge including the filter media as described herein provides a decreased pressure drop when in use, and increases useful operating lifetimes. Because of the increased density from the intermediate pleats as described, the media of the pleated filter media has an increased stiffness, which can further aid manufacturability especially when it comes to attaching end caps to the cartridge assembly. The increased density of the pleat pack may also have the effect of giving the pleated filter cartridge a higher strength with regards to crushing under pressure.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A pleated filtration media for a filter cartridge, the pleated filtration media comprising:
a plurality of circumferentially disposed linear pleats extending from a constant inner core diameter (d) to a constant height (h) defined by an outer diameter; and
one or more intermediate pleats circumferentially disposed between a plurality of adjoining linear pleats, wherein each one of the intermediate pleats has a height less than the constant height, and wherein the height of the intermediate pleats progressively decreases in a clockwise or a counter clockwise direction.

2. The filtration media of claim 1, wherein the filtration media is formed of material selected from the group consisting of felt, paper, wet laid paper, glass fiber, microporous membranes, multilayered composite, and combinations thereof.

3. The filtration media of claim 1, wherein the one or more intermediate pleats are symmetrically disposed between the circumferentially disposed linear pleats such that the same numbers of intermediate pleats are disposed between the adjoining linear pleats.

4. The filtration media of claim 1, wherein the one or more intermediate pleats are asymmetrically disposed within the circumferentially disposed linear pleats having the constant height such that a dissimilar number of intermediate pleats are disposed between at least one of the adjoining linear pleats.

5. The filtration media of claim 1, wherein each one of the intermediate pleats extends inwardly from the outer diameter.

6. The filtration media of claim 1, wherein each adjoining linear pleat has at least one intermediate pleat therebetween.

7. A filtration cartridge comprising:
an annular perforated inner core having a constant diameter;
a filter media radially disposed about the annular perforated inner core, the filter media comprising a plurality of circumferentially disposed linear pleats extending from the inner core to a constant height (h) defined by an outer diameter; and one or more intermediate pleats circumferentially disposed between a plurality of adjoining linear pleats, wherein each one of the intermediate pleats has a height less than the constant height, and wherein the height of the intermediate pleats progressively decreases in a clockwise or a counter clockwise direction; and
end caps disposed at each end, wherein at least one of the end caps includes an inlet in fluid communication with the annular perforated inner core.

8. The filtration cartridge of claim 7, further comprising an outer cage having an inner diameter equal to the outer diameter of the filter media.

9. The filtration cartridge of claim 7, wherein the filtration media is a material selected from the group consisting of felt, paper, wet laid paper, glass fiber, microporous membranes, multilayered composite, and combinations thereof.

10. The filtration cartridge of claim 7, wherein the one or more intermediate pleats are symmetrically disposed between the circumferentially disposed linear pleats such that the same numbers of intermediate pleats are disposed between the adjoining linear pleats such that a dissimilar number of intermediate pleats are disposed between at least one of the adjoining linear pleats.

11. The filtration cartridge of claim 7, wherein the one or more intermediate pleats are asymmetrically disposed within the circumferentially disposed linear pleats having the constant height.

12. The filtration cartridge of claim 7, wherein each one of the intermediate pleats extends inwardly from the outer diameter.

13. The filtration cartridge of claim 7, wherein each adjoining linear pleat has at least one intermediate pleat therebetween.

14. A pleated filtration media for a filter cartridge, the pleated filtration media comprising:
a plurality of circumferentially disposed linear pleats extending from a constant inner core diameter (d) to a constant height (h) defined by an outer diameter; and
one or more intermediate pleats circumferentially disposed between a plurality of adjoining linear pleats, wherein each one of the intermediate pleats has a different height relative to another intermediate pleat.

15. The filtration media of claim 14, wherein the one or more intermediate pleats are symmetrically disposed between the circumferentially disposed linear pleats such that the same numbers of intermediate pleats are disposed between the adjoining linear pleats.

16. The filtration media of claim 14, wherein the one or more intermediate pleats are asymmetrically disposed within the circumferentially disposed linear pleats having the constant height such that a dissimilar number of intermediate pleats are disposed between at least one of the adjoining linear pleats.

17. The filtration media of claim 14, wherein each one of the intermediate pleats extends inwardly from the outer diameter.

18. A method for maximizing surface area for a pleated filtration media for a cartridge filter, the process comprising:
forming a plurality of circumferentially disposed linear pleats extending from the inner core to a constant height (h) defined by an outer diameter; and
forming one or more intermediate pleats between a plurality of adjoining linear pleats, wherein each one of the intermediate pleats has a height less than the constant height, and wherein the height of each one of the intermediate pleats is different.

19. The method of claim 18, wherein the height of each one of the intermediate pleats progressively decreases about a circumference of the filtration media.

20. The method of claim 18, wherein the filter media is formed of a material selected from the group consisting of felt, paper, wet laid paper, glass fiber, microporous membranes, multilayered composite, and combinations thereof.

21. The method of claim 18, wherein forming the intermediate pleats comprises the symmetrically disposing the intermediate pleats between the circumferentially disposed linear pleats such that the same numbers of intermediate pleats are disposed between the adjoining linear pleats.

22. The method of claim 18, wherein forming the intermediate pleats comprises the asymmetrically disposing the intermediate pleats between the circumferentially disposed linear pleats such that a dissimilar number of intermediate pleats are disposed between at least one of the adjoining linear pleats.

23. The method of claim 18, wherein forming the intermediate pleats comprises extending the intermediate pleats inwardly from the outer diameter.

24. The method of claim 18, wherein each adjoining linear pleat has at least one intermediate pleat therebetween.
